(19) United States
(12) Patent Application Publication
(10) Pub. No.: US 2026/0289803 A1
(43) Pub. Date: Sep. 24, 2026

(54) GROOVE DEPTH CALCULATION APPARATUS, GROOVE DEPTH CALCULATION METHOD, AND NON-TRANSITORY COMPUTER-READABLE MEDIUM

(71) Applicant: NEC Corporation, Tokyo (JP)

(72) Inventors: Yuka OSHIMA, Tokyo (JP); Erina KITAHARA, Tokyo (JP); Satoshi KISHIMA, Tokyo (JP); Yasutoshi FUKAYA, Tokyo (JP); Chinami TAKAHASHI, Tokyo (JP)

(73) Assignee: NEC Corporation, Tokyo (JP)

(21) Appl. No.: 19/475,832

(22) PCT Filed: Apr. 28, 2023
(86) PCT No.: PCT/JP2023/016839

§ 371 Date: Oct. 16, 2025

(51) Int. Cl. G06T 7/55; G01M 17/02

(52) U.S. Cl. CPC G06T 7/55; G01M 17/027; G06T 2207/10028

(57) ABSTRACT

A groove depth calculation apparatus generates three-dimensional data representing the three-dimensional shape of a tire by using a plurality of captured images in which the tire is imaged. The groove depth calculation apparatus uses the three-dimensional data to calculate the virtual-space depth of longitudinal grooves of the tire and the virtual-space distance between the longitudinal grooves of the tire. The groove depth calculation apparatus identifies the real-world distance between the longitudinal grooves of the tire. The groove depth calculation apparatus calculates the real-world depth of the longitudinal grooves of the tire on the basis of the virtual-space distance between the longitudinal grooves of the tire, the real-world distance between the longitudinal grooves of the tire, and the virtual-space depth of the longitudinal grooves of the tire.

### TECHNICAL FIELD

The present disclosure relates to a groove depth calculation apparatus, a groove depth calculation method, and a non-transitory computer-readable medium.

### BACKGROUND ART

A tire mounted on a vehicle such as an automobile or a motorcycle is provided with a groove. The groove of the tire becomes shallow due to wear of the ground contact surface of the tire. Therefore, whether the depth of the groove of the tire is sufficient may be checked.

An information processing system that measures the depth of a tire groove has been developed. PTL 1 discloses a technique for calculating the depth of a groove of a tire by projecting a specific pattern on the tire and imaging the tire on which the pattern is projected with a camera. PTL 2 discloses a technique of acquiring 3D data of a tire using a 3D scanner and calculating a depth of a groove of the tire using the 3D data.

### CITATION LIST

### Patent Literature

PTL 1: JP 2022-166698 A
PTL 2: JP 2020-165895 A

### SUMMARY OF INVENTION

### Technical Problem

When the technique of PTL 1 is used, an apparatus capable of posting a predetermined pattern on a tire is required. PTL 2 does not mention a method of calculating the real-world depth of the groove from the groove depth of the tire on the 3D data (in other words, in the virtual space). The present disclosure has been made in view of this problem, and an object thereof is to provide a new technology for calculating a real-world depth of a groove of a tire.

### Solution to Problem

A groove depth calculation apparatus according to the present disclosure comprises: a generation means for generating three-dimensional data representing a shape of a tire by using a plurality of captured images in which the same tire is captured; a first calculation means for calculating a virtual-space depth of a longitudinal groove of the tire and a virtual-space distance between longitudinal grooves of the tire by using the three-dimensional data; a determination means for determining a real-world distance between the longitudinal grooves of the tire; and a second calculation means for calculating a real-world depth of the longitudinal groove of the tire based on a virtual-space distance between the longitudinal grooves of the tire, a real-world distance between the longitudinal grooves of the tire, and a virtual-space depth of the longitudinal groove of the tire.

A groove depth calculation method according to the present disclosure is executed by a computer. The method includes: a generation step of generating three-dimensional data representing a shape of a tire by using a plurality of captured images in which the same tire is captured; a first calculation step of calculating a virtual-space depth of a longitudinal groove of the tire and a virtual-space distance between longitudinal grooves of the tire by using the three-dimensional data; a determination step of determining a real-world distance between the longitudinal grooves of the tire; and a second calculation step of calculating a real-world depth of the longitudinal groove of the tire based on a virtual-space distance between the longitudinal grooves of the tire, a real-world distance between the longitudinal grooves of the tire, and a virtual-space depth of the longitudinal groove of the tire.

A non-transitory computer-readable medium of the present disclosure stores a program for causing a computer to execute the groove depth calculation method of the present disclosure.

### Advantageous Effects of Invention

According to the present disclosure, there is provided a new technology for calculating a real-world depth of a groove of a tire.

### BRIEF DESCRIPTION OF DRAWINGS

FIG. 1 is a diagram illustrating an outline of an operation of a groove depth calculation apparatus of a first example embodiment.

FIG. 2 is a block diagram illustrating a functional configuration of the groove depth calculation apparatus according to the first example embodiment.

FIG. 3 is a block diagram illustrating a hardware configuration of a computer that implements the groove depth calculation apparatus in the first example embodiment.

FIG. 4 is a flowchart illustrating a flow of processing executed by the groove depth calculation apparatus of the first example embodiment.

FIG. 5 is a diagram illustrating a state in which a part of three-dimensional data is cut out.

FIG. 6 is a diagram illustrating a configuration of specification information.

FIG. 7 is a first diagram illustrating an implementation example of the groove depth calculation apparatus.

FIG. 8 is a second diagram illustrating an implementation example of the groove depth calculation apparatus.

### EXAMPLE EMBODIMENT

Hereinafter, example embodiments of the present disclosure will be described in detail with reference to the drawings. In the drawings, the same or related elements are denoted by the same reference numerals, and repeated description is omitted as necessary for clarity of description. Unless otherwise described, preset values such as predetermined values or threshold values are stored in advance in a storage device or the like accessible from a device using the values. Furthermore, unless otherwise described, the storage unit includes one or more storage devices of any number.

### First Example Embodiment

### Overview

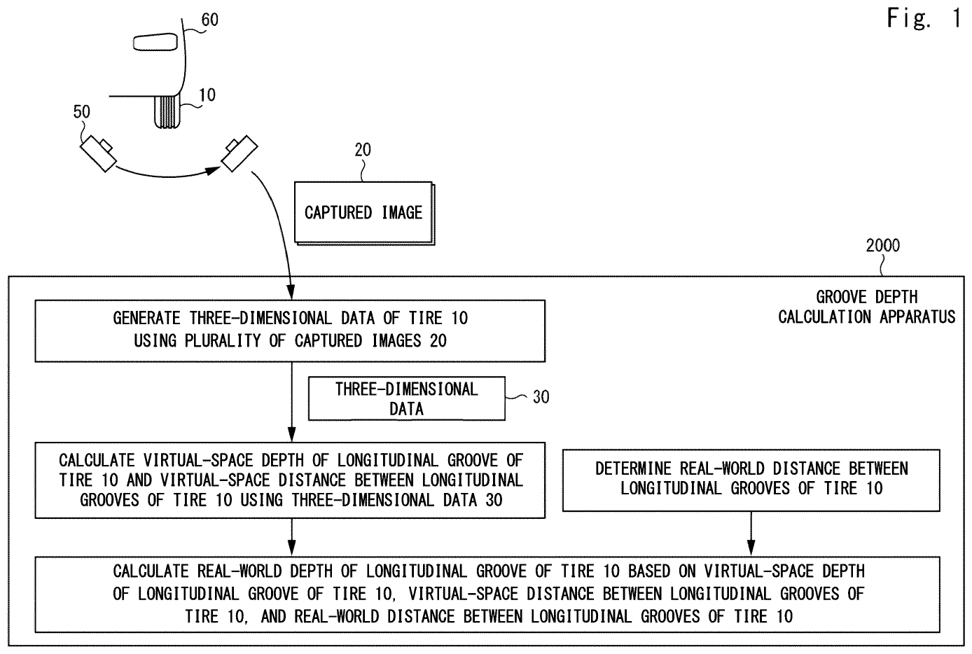

FIG. 1 is a diagram illustrating an outline of an operation of a groove depth calculation apparatus 2000 of a first example embodiment. Here, FIG. 1 is a diagram for facilitating understanding of the overview of the groove depth calculation apparatus 2000, and an operation of the groove depth calculation apparatus 2000 is not limited to that illustrated in FIG. 1.

The groove depth calculation apparatus 2000 is used to calculate the depth of the longitudinal groove of a tire 10. The tire 10 is a tire of an arbitrary vehicle such as an automobile or a motorcycle. Here, the longitudinal groove is a groove provided along the circumference of the tire. Hereinafter, the “longitudinal groove” may be simply referred to as a “groove”.

The groove depth calculation apparatus 2000 acquires a plurality of captured images 20 generated by capturing an image of the tire 10 with a camera 50. The plurality of captured images 20 include at least two captured images 20 in which the tire 10 is captured when viewed from different directions. For example, in a certain captured image 20, the tire 10 viewed from diagonally front left is captured, while in another captured image 20, the tire 10 viewed from diagonally front right is captured.

There are various methods for generating the plurality of captured images 20 in which the tire 10 is captured when viewed from different directions. For example, there is a method of “imaging the tire 10 a plurality of times while changing attitude and position of the camera 50 with attitude of the tire 10 fixed”. In addition, for example, there is a method of “imaging the tire 10 a plurality of times with a camera in which attitude and position are fixed while changing attitude of the tire 10”.

The groove depth calculation apparatus 2000 generates three-dimensional data 30 representing the shape of the tire 10 using the plurality of captured images 20. The three-dimensional data 30 is, for example, point cloud data indicating a virtual-space position for each of a plurality of locations of the tire 10. The three-dimensional data 30 is not necessarily three-dimensional data of the entire tire 10, and may be three-dimensional data of a part of the tire 10.

The virtual space here is a virtual space to which the three-dimensional data 30 belongs. The position of each point of the three-dimensional data 30 is represented by a relative position (coordinates) with respect to the origin of the specific virtual space. Therefore, the distance and depth calculated using the coordinates are the distance and depth on the virtual space.

The groove depth calculation apparatus 2000 determines the virtual-space depth of the longitudinal groove of the tire 10 and the virtual-space distance between the longitudinal grooves of the tire 10 using the three-dimensional data 30. The groove depth calculation apparatus 2000 determines a real-world distance between the longitudinal grooves provided in the tire 10. For example, the real-world distance between the longitudinal grooves is determined using specification information indicating the specification of the tire 10. In addition, for example, the real-world distance between the longitudinal grooves may be input by the user of the groove depth calculation apparatus 2000. Then, the groove depth calculation apparatus 2000 calculates the real-world distance of the longitudinal grooves of the tire 10 based on the virtual-space distance between the longitudinal grooves of the tire 10, the real-world distance between the longitudinal grooves of the tire 10, and the virtual-space depth of the longitudinal groove of the tire 10.

Hereinafter, the depth and the distance on the virtual space are also referred to as a virtual depth and a virtual distance. Similarly, the depth and the real-world distance are also expressed as a real depth and a real distance.

### <Example of Operation and Effect>

Neither PTL 1 nor PTL 2 discloses that specification information indicating a real-world distance between longitudinal grooves of a tire is used to calculate a real-world depth of the longitudinal groove of the tire. Therefore, according to the groove depth calculation apparatus 2000, the real-world depth of the longitudinal groove of the tire is calculated by a method different from the method disclosed in PTL 1 and also different from the method disclosed in PTL 2. Therefore, according to the present disclosure, there is provided a new technology for calculating a real-world depth of a longitudinal groove of a tire.

In the case of using the groove depth calculation apparatus 2000 of the present example embodiment, unlike the case of using the system of PTL 1, it is not necessary to project a predetermined pattern to the tire 10. Therefore, the groove depth calculation apparatus 2000 can be configured at a lower cost than the system of PTL 1.

Hereinafter, the groove depth calculation apparatus 2000 of the present example embodiment will be described in more detail.

### <Example of Functional Configuration>

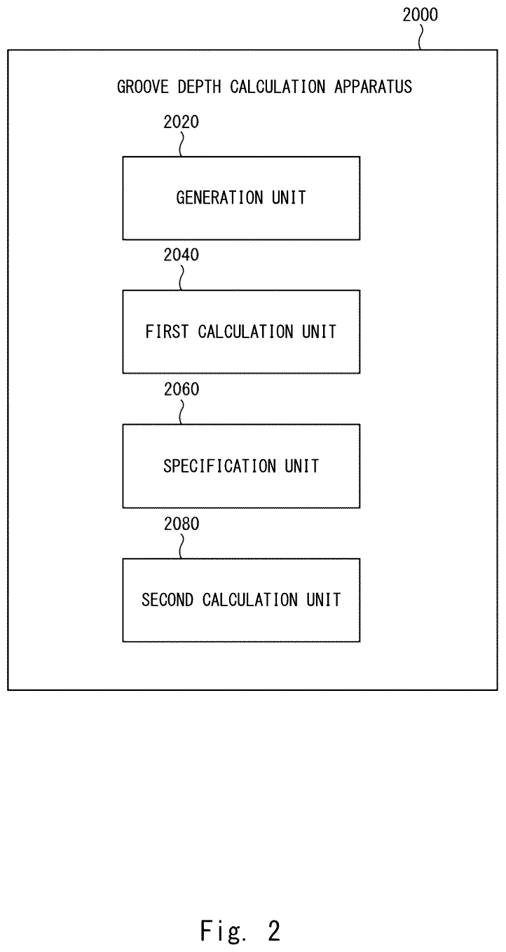

FIG. 2 is a block diagram illustrating a functional configuration of the groove depth calculation apparatus 2000 according to the first example embodiment. The groove depth calculation apparatus 2000 includes a generation unit 2020, a first calculation unit 2040, a determination unit 2060, and a second calculation unit 2080. The generation unit 2020 generates the three-dimensional data 30 representing the shape of the tire 10 by using the plurality of captured images 20. The first calculation unit 2040 uses the three-dimensional data 30 to calculate the virtual depth of the longitudinal groove of the tire 10 and the virtual distance between the longitudinal grooves of the tire 10. The determination unit 2060 determines the real distance between the longitudinal grooves of the tire 10. The second calculation unit 2080 calculates the real depth of the longitudinal groove of the tire 10 based on the virtual distance between the longitudinal grooves of the tire 10, the real distance between the longitudinal grooves of the tire 10, and the virtual depth of the longitudinal groove of the tire 10.

### <Example of Hardware Configuration>

Each functional component of the groove depth calculation apparatus 2000 may be implemented by hardware that implements each functional component (for example, a hard-wired electronic circuit) or may be implemented by a combination of hardware and software (for example, a combination of an electronic circuit and a program that controls the electronic circuit or the like). Hereinafter, a case where each functional component of the groove depth calculation apparatus 2000 is implemented by a combination of hardware and software will be further described.

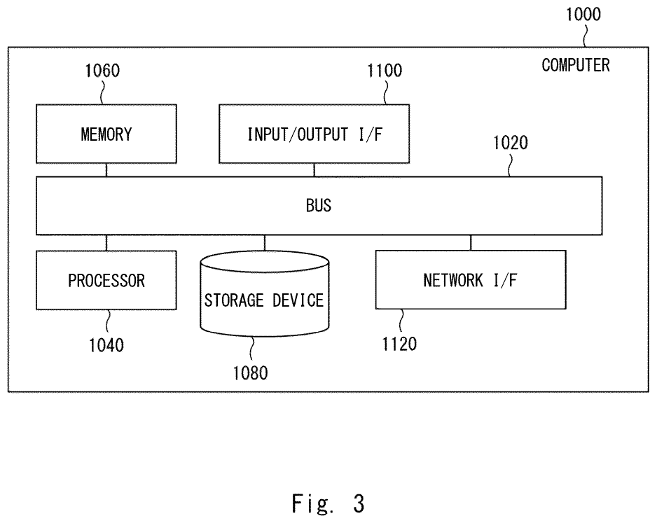

FIG. 3 is a block diagram illustrating a hardware configuration of a computer 1000 that implements the groove depth calculation apparatus 2000. The computer 1000 is any computer. For example, the computer 1000 is a stationary computer such as a personal computer (PC) or a server machine. In another example, the computer 1000 is a portable computer such as a smartphone or a tablet terminal. The computer 1000 may be a dedicated computer designed to implement the groove depth calculation apparatus 2000 or may be a general-purpose computer.

For example, by installing a predetermined application with respect to the computer 1000, each function of the groove depth calculation apparatus 2000 is implemented by the computer 1000. The above-described application is configured with a program for implementing the functional components of the groove depth calculation apparatus 2000. The method of acquiring the program is arbitrary. For example, the program can be acquired from a storage medium (such as a digital versatile disc (DVD) disk or a universal serial bus (USB) memory) in which the program is stored. In addition, for example, the program can be acquired by downloading the program from a server apparatus that manages a storage apparatus in which the program is stored.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, a method of connecting the processor 1040 and the like to each other is not limited to the bus connection.

The processor 1040 is any of various kinds of processors such as a central processing unit (CPU), a graphics processing unit (GPU), or a field-programmable gate array (FPGA). The memory 1060 is a primary storage device implemented using a random access memory (RAM) or the like. The storage device 1080 is an auxiliary storage device implemented using a hard disk, a solid state drive (SSD), a memory card, a read only memory (ROM), or the like.

The input/output interface 1100 is an interface connecting the computer 1000 with an input/output device. For example, an input device such as a keyboard and an output device such as a display device are connected to the input/output interface 1100.

The network interface 1120 is an interface connecting the computer 1000 to a network. The network may be a Local Area Network (LAN) or a Wide Area Network (WAN).

The storage device 1080 stores a program (a program for implementing the above-described application) for implementing each functional component of the groove depth calculation apparatus 2000. The processor 1040 reads the program to the memory 1060 and executes the program to implement each functional component of the groove depth calculation apparatus 2000.

The groove depth calculation apparatus 2000 may be implemented by one computer 1000 or may be implemented by the plurality of computers 1000. In the latter case, the configurations of the computers 1000 do not need to be the same, and can be different from each other.

### <Regarding Camera 50>

The camera 50 is an arbitrary device having an imaging function. The camera 50 may be a still camera that generates a still image or a video camera that generates a moving image. The camera 50 may be built in a portable terminal such as a smartphone or may be configured alone.

### <Flow of Processing>

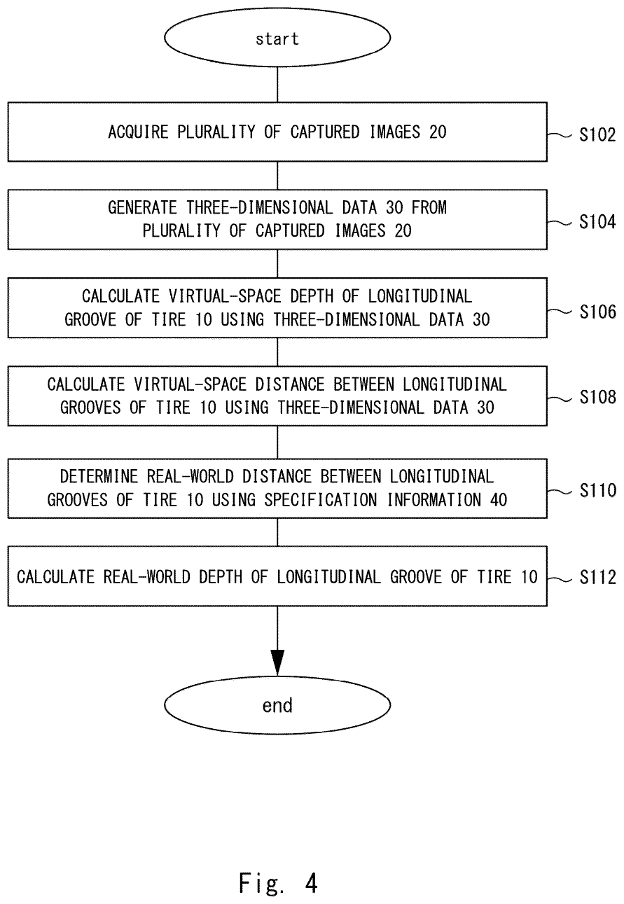

FIG. 4 is a flowchart illustrating a flow of processing executed by the groove depth calculation apparatus 2000 of the first example embodiment. The generation unit 2020 acquires the plurality of captured images 20 (S102). The generation unit 2020 generates the three-dimensional data 30 using the plurality of captured images 20 (S104). The first calculation unit 2040 calculates the virtual depth of the longitudinal groove of the tire 10 using the three-dimensional data 30 (S106). The first calculation unit 2040 calculates the virtual distance between the longitudinal grooves of the tire 10 using the three-dimensional data 30 (S108). The determination unit 2060 determines a real distance between the longitudinal grooves of the tire 10 (S110). The second calculation unit 2080 calculates the real depth of the longitudinal groove of the tire 10 based on the virtual distance between the longitudinal grooves of the tire 10, the real distance between the longitudinal grooves of the tire 10, and the virtual depth of the longitudinal groove of the tire 10 (S112).

The flow of processing executed by the groove depth calculation apparatus 2000 is not limited to the flow illustrated in FIG. 4. For example, the processing of S102 to S108 may be executed after the processing of S110, or may be executed in parallel with the processing of S110. The processing of S108 may be executed before the processing of S106, or may be executed in parallel with the processing of S106.

<Acquisition of Captured image 20: S102>

The generation unit 2020 acquires the plurality of captured images 20 (S102). There are various methods for acquiring the plurality of captured images 20. For example, the camera 50 is configured to store the generated captured image 20 in a storage unit accessible from the generation unit 2020. In this case, the generation unit 2020 acquires the captured image 20 by reading the captured image 20 from the storage unit. In addition, for example, the camera 50 is configured to transmit the generated captured image 20 to the groove depth calculation apparatus 2000. In this case, the generation unit 2020 acquires the captured image 20, by receiving the captured image 20 transmitted from the camera 50. An example of a more specific acquisition method of the captured image 20 will be described later.

### <Generation of Three-Dimensional Data 30: S104>

The generation unit 2020 generates the three-dimensional data 30 using the plurality of captured images 20 (S104). As a specific technique for generating, from a plurality of images, three-dimensional data representing the shape of an object included in the plurality of images, an existing technique such as structure from motion (SfM) can be used.

### <Virtual Depth of Longitudinal Groove of Tire 10: S106>

The first calculation unit 2040 calculates the virtual depth of the tire 10 using the three-dimensional data 30 (S106). For this purpose, for example, the first calculation unit 2040 detects the ground contact surface of the tire 10 and the bottom surface of the groove of the tire 10 from the three-dimensional data 30.

As a method of detecting the ground contact surface of the tire 10 and the bottom surface of the groove from the three-dimensional data 30, various methods can be used. For example, the first calculation unit 2040 detects a plurality of planes from the three-dimensional data 30 by executing plane estimation processing on the three-dimensional data 30. Then, the first calculation unit 2040 detects a plane having the largest area among the planes detected from the three-dimensional data 30 as the ground contact surface of the tire 10. On the other hand, the first calculation unit 2040 detects a plane having the smallest area among the planes detected from the three-dimensional data 30 as the bottom surface of the longitudinal groove of the tire 10.

However, there may be a plane (for example, the bottom surface of the lateral groove) having an area smaller than the bottom surface of the longitudinal groove. Therefore, the first calculation unit 2040 may detect, as the bottom surface of the longitudinal groove, a plane having the smallest area among planes having an area equal to or larger than the threshold, detected from the three-dimensional data 30. This is because a plane having an area less than the threshold is estimated to represent a small surface such as a lateral groove or a scratch.

Here, the ground contact surface and the longitudinal groove of the tire 10 are curved so as to draw a circle when viewed from the side of the tire 10. Therefore, the first calculation unit 2040 may perform the plane estimation processing on not the three-dimensional data of the entire tire 10 but the three-dimensional data of a part of the tire 10. Therefore, for example, the first calculation unit 2040 cuts out three-dimensional data of a predetermined size from the three-dimensional data 30, and performs plane estimation on the cut out three-dimensional data.

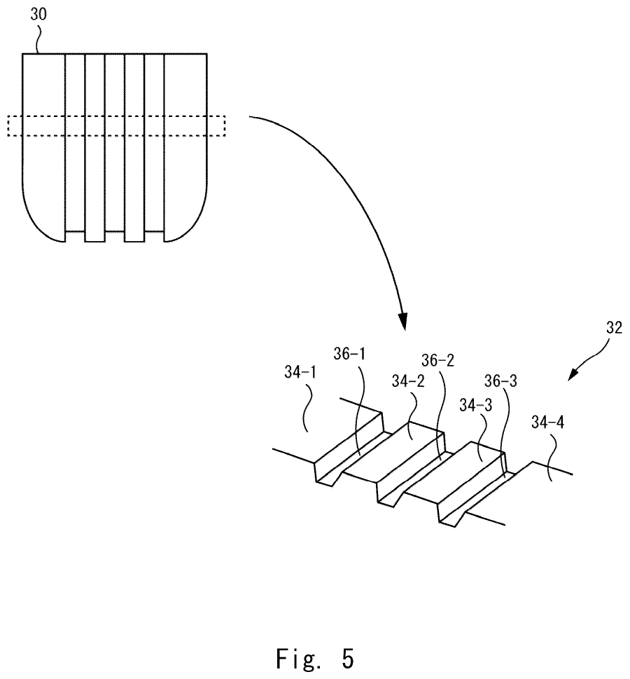

FIG. 5 is a diagram illustrating a state in which a part of the three-dimensional data 30 is cut out. The three-dimensional data 30 in FIG. 5 is three-dimensional data generated for a portion (in other words, a range in which an image can be easily captured in a state of being attached to the body) of the tire 10 that is not hidden by the body of the vehicle 60. The first calculation unit 2040 cuts out three-dimensional data 32 from the dotted line portion of the three-dimensional data 30. Then, the first calculation unit 2040 performs plane estimation processing on the three-dimensional data 32.

In FIG. 5, four planes, that is, a plane 34-1, a plane 34-2, a plane 34-3, and a plane 34-4, represent the ground contact surface of the tire 10. The planes representing the bottom surfaces of the longitudinal grooves are a plane 36-1, a plane 36-2, and a plane 36-3. If the plane with the largest area is detected as the ground contact surface, any one of the planes 34-1 to 34-4 is detected as the ground contact surface. On the other hand, when the plane having the smallest area is detected as the bottom surface of the longitudinal groove, any one of the planes 36-1 to 36-3 is detected as the bottom surface of the longitudinal groove.

The ground contact surface of the tire 10 and the bottom surface of the longitudinal groove may be detected using semantic segmentation. In this case, the first calculation unit 2040 classifies the point cloud data constituting the three-dimensional data 30 for each class by executing semantic segmentation on the three-dimensional data 30. Here, the class includes at least two classes of a ground contact surface and a bottom surface of the longitudinal groove. In this case, for example, the first calculation unit 2040 detects a point cloud classified into a class of a ground contact surface as the ground contact surface. Similarly, the first calculation unit 2040 detects a point cloud classified into a class of a bottom surface of the longitudinal groove as the bottom surface of the longitudinal groove.

Here, various methods can be used as a method for realizing semantic segmentation. For example, the first calculation unit 2040 includes a class classifier that performs semantic segmentation. The class classifier includes a machine learning model such as a neural network. The class classifier is pre-trained to determine a class of each location (for example, each point) of the input three-dimensional data. The training data used for this training includes, for example, three-dimensional data of a tire and a set of labels indicating a class of each place of the three-dimensional data.

In addition, for example, the first calculation unit 2040 may detect the ground contact surface of the tire 10 and the bottom surface of the longitudinal groove based on the pixel value of the captured image 20 (for example, based on brightness, saturation, or hue). For example, for each plane detected from the three-dimensional data 30 by the plane estimation processing, the first calculation unit 2040 determines whether the brightness of each pixel on the captured image 20 relevant to the plane is included in the predetermined first range. In a case where all or a predetermined proportion or more of the pixels in the captured image 20 relevant to the plane are included in the first range, the first calculation unit 2040 determines that the plane represents the ground contact surface.

Similarly, for each plane detected from the three-dimensional data 30, the first calculation unit 2040 determines whether the brightness of each pixel on the captured image 20 relevant to the plane is included in a predetermined second range. Here, the first range and the second range are numerical ranges that do not overlap each other. In a case where all or a predetermined proportion or more of the pixels in the captured image 20 relevant to the plane are included in the second range, the first calculation unit 2040 determines that the plane represents the bottom surface of the longitudinal groove.

### <Virtual Distance Between Grooves of Tire 10: S108>

The first calculation unit 2040 calculates the virtual-space distance between the grooves of the tire 10 using the three-dimensional data 30 (S108). For example, the first calculation unit 2040 detects a plurality of regions representing longitudinal grooves from the three-dimensional data 30 by using the semantic segmentation described above. Then, the first calculation unit 2040 calculates, as a virtual-space distance between the longitudinal grooves of the tire 10, a virtual-space distance between two regions representing the two longitudinal grooves adjacent to each other.

Here, it is assumed that three or more longitudinal grooves are provided in the tire 10. In this case, for example, the first calculation unit 2040 calculates the distance between the longitudinal grooves for each of all pairs of the longitudinal grooves adjacent to each other. In addition, for example, the first calculation unit 2040 may calculate the distance between the longitudinal grooves for one predetermined pair (for example, the first longitudinal groove from the left and the second longitudinal groove from the left).

### <Real Distance Between Longitudinal Grooves of Tire 10: S110>

The determination unit 2060 determines a real distance between the longitudinal grooves of the tire 10 (S110). For example, the real distance between the longitudinal grooves of the tire 10 is determined using the specification information. Hereinafter, a method of determining the real distance between the longitudinal grooves using the specification information will be specifically described.

The specification information is information indicating a specification of the tire 10, and indicates at least a real distance between the longitudinal grooves of the tire 10. The determination unit 2060 acquires the specification information, and refers to the acquired specification information to determine the real distance between the longitudinal grooves of the tire 10.

The real distance between the longitudinal grooves may vary depending on the type of a tire. Therefore, for example, the specification information indicates the real distance between the longitudinal grooves of the tire in association with the identification information of the tire. The identification information of the tire is, for example, a model number of the tire.

When the tire has three or more longitudinal grooves, it is conceivable that the longitudinal grooves are not arranged at equal intervals. For example, in a case of a certain tire, a real distance between a first longitudinal groove from the left and a second longitudinal groove from the left is d1, and a real distance between a second longitudinal groove from the left and a third longitudinal groove from the left is d2 (d1≠d2). In such a case, the specification information may indicate the real distance between the longitudinal grooves for each of a plurality of pairs of the longitudinal grooves adjacent to each other.

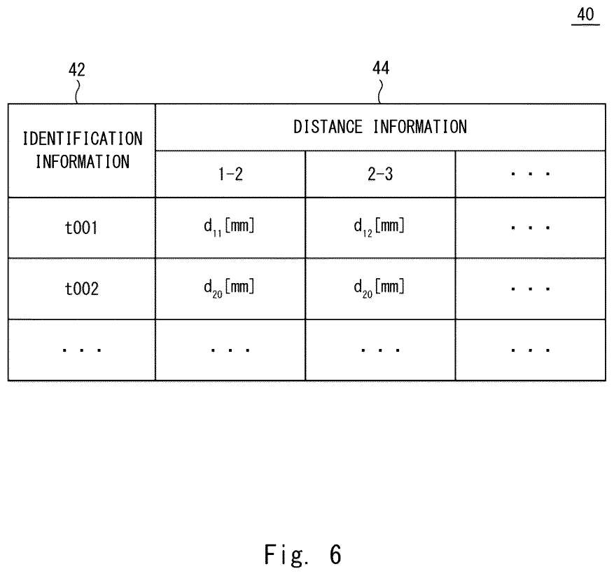

FIG. 6 is a diagram illustrating a configuration of specification information 40. In FIG. 6, the specification information 40 has two columns of identification information 42 and distance information 44. The identification information 42 indicates identification information of a tire. The distance information 44 indicates a real distance between the longitudinal grooves for each pair of the longitudinal grooves adjacent to each other. In FIG. 6, the pair of the i-th longitudinal groove from the left and the j-th longitudinal groove from the left is represented as “i-j”. For example, the pair of the first longitudinal groove from the left and the second longitudinal groove from the left is represented as “1-2”.

Here, in the example of FIG. 6, the longitudinal grooves of a tire t002 are arranged at equal intervals. Therefore, in 1-2 and 2-3, the same length d20 [mm] is shown.

The configuration of the specification information 40 is not limited to that illustrated in FIG. 6. For example, in a case where three or more longitudinal grooves are arranged at equal intervals, the distance information 44 may be configured to indicate only one real distance between the longitudinal grooves. In addition, for example, in a case where three or more longitudinal grooves are not arranged at equal intervals, the distance information may be configured to indicate only the real distance for a representative pair of longitudinal grooves (for example, a pair of a first longitudinal groove from the left and a second longitudinal groove from the left).

In order to obtain information on the tire 10 from the specification information 40, the determination unit 2060 determines identification information of the tire 10. Then, the determination unit 2060 acquires the distance information 44 from the record of the specification information 40 in which the determined identification information is indicated in the identification information 42, thereby determining the real distance between the longitudinal grooves in the tire 10.

Here, as illustrated in FIG. 6, it is assumed that the specification information 40 indicates a real distance between longitudinal grooves for each of a plurality of pairs of longitudinal grooves for the tire 10. In this case, the determination unit 2060 determines the real distance between the longitudinal grooves of the tire 10 by referring to one or more of the plurality of real distances from the specification information 40.

For example, the determination unit 2060 determines the distance between the longitudinal grooves of the tire 10 by referring to the specification information 40 for one predetermined pair among a plurality of pairs of longitudinal grooves of the tire 10. For example, it is assumed that “first and second longitudinal grooves from the left” are defined as a pair of longitudinal grooves whose real distance should be referred to. In this case, the determination unit 2060 determines the real distance indicated by “1-2” of the distance information 44 of the record indicating the identification information of the tire 10 as the real distance between the longitudinal grooves of the tire 10.

In addition, for example, the determination unit 2060 may determine the real distance between the longitudinal grooves with reference to the specification information 40 for each of all pairs of the longitudinal grooves of the tire 10.

There are various methods for determining the identification information of the tire 10. For example, the identification information of the tire 10 is input by the user. In this case, for example, the determination unit 2060 presents a screen prompting the user to input the identification information of the tire 10. The user inputs identification information of the tire 10 on the screen. Accordingly, the determination unit 2060 determines the identification information of the tire 10.

In addition, for example, the determination unit 2060 determines the identification information of the tire 10 based on the identification information of the vehicle 60. For example, by determining a manufacturer, a vehicle type, and a grade of a vehicle, it is possible to determine a standard tire attached to the vehicle at the time of purchase. Therefore, information (hereinafter, vehicle information) that associates identification information of a vehicle with identification information of a standard tire attached to the vehicle at the time of purchase is stored in a storage unit accessible from the groove depth calculation apparatus 2000 in advance.

For example, the determination unit 2060 presents a screen prompting the user to input identification information (for example, a combination of a manufacturer, a vehicle type, and a grade) of the vehicle 60. The user inputs identification information of the vehicle 60 on the screen. Accordingly, the determination unit 2060 determines identification information of the vehicle 60. Then, the determination unit 2060 acquires the identification information of the tire 10 associated with the identification information of the determined vehicle 60 from the vehicle information.

In addition, for example, the user of the groove depth calculation apparatus 2000 may register the identification information of the vehicle 60, the identification information of the tire 10, or both of them in the groove depth calculation apparatus 2000 in advance. For example, as will be described later, it is assumed that the function of the groove depth calculation apparatus 2000 is implemented by an application installed in a mobile terminal of the owner of the vehicle 60. In this case, the owner of the vehicle 60 registers information on the vehicle 60 in the application in advance. In this way, it is not necessary to input the identification information of the vehicle 60 and the identification information of the tire 10 every time the groove depth calculation apparatus 2000 is used, and thus the convenience of the groove depth calculation apparatus 2000 is improved. The identification information of the vehicle 60 and the tire 10 registered in advance is stored in a storage unit accessible from the above application.

### <Real Depth of Longitudinal Groove of Tire 10: S112>

The second calculation unit 2080 calculates the real depth of the longitudinal groove of the tire 10 based on the virtual distance between the longitudinal grooves of the tire 10, the real distance between the longitudinal grooves of the tire 10, and the virtual depth of the longitudinal groove of the tire 10 (S112). The second calculation unit 2080 compares the virtual distance and the real distance with respect to the distance between the longitudinal grooves of the tire 10, thereby determining the ratio between the virtual-space length and the real-world length. Then, the second calculation unit 2080 calculates the real depth of the longitudinal groove of the tire 10 from the virtual depth of the longitudinal groove of the tire 10 based on the ratio.

For example, the second calculation unit 2080 calculates the real depth of the longitudinal groove of the tire 10 using the following Expressions (1) and (2).

$$\begin{matrix}[ Math . 1 ] & \\ Dr = Dv * p & ( 1 )\end{matrix}$$

$$\begin{matrix}[ Math . 2 ] & \\ p = \frac{Lr}{Lv} & ( 2 )\end{matrix}$$

Here, Dr represents the real depth of the longitudinal groove of the tire 10. Dv represents the virtual depth of the longitudinal groove of the tire 10. p represents a ratio of the length in the real space to the virtual-space length. Lr represents a real distance between the longitudinal grooves of the tire 10. Lv represents a virtual distance between the longitudinal grooves of the tire 10.

Here, it is assumed that a real distance and a virtual distance are determined for each of a plurality of pairs of longitudinal grooves of the tire 10. In this case, the ratio p may be calculated using the real distance and the virtual distance calculated for each of the plurality of pairs. For example, the second calculation unit 2080 calculates a ratio of the real distance to the virtual distance for each of a plurality of pairs of longitudinal grooves of the tire 10, and uses statistical values (average value, median value, maximum value, minimum value, or the like) of the plurality of calculated ratios as the ratio p. In addition, for example, a ratio of a statistical value (statistical value of Lr) of a real distance calculated for each pair of longitudinal grooves of the tire 10 to a statistical value (statistical value of Lv) of a virtual distance calculated for each pair of longitudinal grooves of the tire 10 may be used as the ratio p.

It is assumed that a plurality of longitudinal grooves are detected from the tire 10, and the virtual depth is calculated for each longitudinal groove. In this case, the second calculation unit 2080 may calculate the real depth for each of the plurality of longitudinal grooves, or may calculate the real depth only for a longitudinal groove having the shortest virtual depth (shallowest longitudinal groove).

Here, a range of values that can be taken by the real depth of the longitudinal groove may be determined in advance. In a case where the real depth of the longitudinal groove calculated by the second calculation unit 2080 is not included in this numerical range, it is considered that the real depth of the longitudinal groove has not been calculated normally. For example, there may be a case where the real depth of the longitudinal groove of the tire 10 cannot be normally calculated because the tire 10 cannot be correctly photographed by the camera 50.

Therefore, for example, the second calculation unit 2080 determines whether the calculated real depth of the longitudinal groove is included in a predetermined numerical range. Then, in a case where the real depth of the longitudinal groove is not included in the predetermined numerical range, the second calculation unit 2080 performs predetermined error handling processing. For example, the error handling processing is a process of outputting an error notification. The error notification is, for example, a notification for requesting re-photographing of the tire 10 using the camera 50. When the image capturing of the tire 10 is performed again in accordance with the error notification, the groove depth calculation apparatus 2000 generates the three-dimensional data 30 again using the plurality of captured images 20 generated by the image capturing again, and calculates the real depth of the longitudinal groove of the tire 10 using the three-dimensional data 30.

### <Output of Result>

The groove depth calculation apparatus 2000 outputs information (hereinafter, output information) regarding the real depth of the longitudinal groove of the tire 10 in various modes. For example, the groove depth calculation apparatus 2000 displays the output information on a display apparatus that can be browsed by the user of the groove depth calculation apparatus 2000. In addition, for example, the groove depth calculation apparatus 2000 stores the output information in an arbitrary storage unit. In addition, for example, the groove depth calculation apparatus 2000 transmits the output information to an arbitrary terminal used by the user of the groove depth calculation apparatus 2000.

The information included in the output information varies. For example, the output information indicates the real depth for each of the one or more longitudinal grooves. In addition, for example, the groove depth calculation apparatus 2000 may indicate the degree of wear of the tire 10 in addition to or instead of the real depth of the longitudinal groove.

When the degree of wear of the tire 10 is included in the output information, the groove depth calculation apparatus 2000 determines the degree of wear of the tire 10. For example, in a case where the real depth of the longitudinal groove of the tire 10 is equal to or greater than the threshold value, the groove depth calculation apparatus 2000 determines that the state of the tire 10 is good (the degree of wear of the tire 10 is low). On the other hand, in a case where the real depth of the longitudinal groove of the tire 10 is less than the threshold value, the groove depth calculation apparatus 2000 determines that the state of the tire 10 is not good (the degree of wear of the tire 10 is high).

A plurality of ranks may be determined for the degree of wear of the tire 10. In this case, a plurality of numerical ranges and ranks are associated with the real depth of the longitudinal grooves. The determination unit 2060 determines a numerical range including the real depth of the tire 10, and determines a rank relevant to the determined numerical range as a rank indicating the degree of wear of the tire 10.

When the real depth is calculated for each of the plurality of longitudinal grooves, the determination unit 2060 may calculate the degree of wear of the tire 10 using the shortest real depth, or may calculate the degree of wear for each longitudinal groove.

### <Implementation Example of Groove Depth Calculation Apparatus 2000>

In order to facilitate understanding of the groove depth calculation apparatus 2000, a more specific implementation example of the groove depth calculation apparatus 2000 will be described. The following example is an example of a specific implementation method of the groove depth calculation apparatus 2000, and a specific implementation method of the groove depth calculation apparatus 2000 is not limited to the following example.

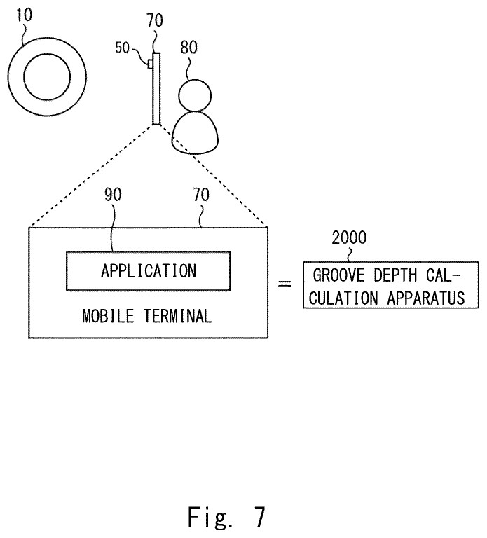

FIG. 7 is a first diagram illustrating an implementation example of the groove depth calculation apparatus 2000. The groove depth calculation apparatus 2000 in FIG. 7 is implemented by using a mobile terminal 70. The mobile terminal 70 is, for example, a smartphone or a tablet terminal. The user 80 who uses the mobile terminal 70 is an arbitrary person such as an owner of the vehicle 60, a worker of a dealer, or a worker of a shop that sells parts such as tires.

An application 90 for causing the mobile terminal 70 to function as the groove depth calculation apparatus 2000 is installed in the mobile terminal 70. The application 90 also functions as an interface between the user 80 and the groove depth calculation apparatus 2000.

The user 80 operates the mobile terminal 70 to start the application 90. The application 90 activates the camera 50 and sets the mode of the camera 50 to a mode for capturing a moving image. Furthermore, the application 90 instructs the user 80 to perform an operation of “moving the position of the mobile terminal 70 in a state where the tire 10 is included in the imaging range of the camera 50”. The user 80 moves the position of the mobile terminal 70 according to the instruction. As a result, a moving image including the tire 10 is generated. Here, the above instruction may include an instruction regarding a speed of moving the mobile terminal 70 (camera 50), a distance of the mobile terminal 70 (camera 50) with respect to the tire 10, or an angle of the mobile terminal 70 (camera 50) with respect to the tire 10.

The application 90 generates the three-dimensional data 30 by using each of two or more moving image frames constituting the moving image as the captured image 20. Here, before generating the three-dimensional data 30, the groove depth calculation apparatus 2000 may determine whether the speed of the mobile terminal 70, the distance of the mobile terminal 70 to the tire 10, or the angle of the mobile terminal 70 to the tire 10 satisfies a predetermined standard for the mobile terminal 70 when the tire 10 is imaged. In a case where the speed or the like of the mobile terminal 70 satisfies the predetermined criterion, the groove depth calculation apparatus 2000 generates the three-dimensional data 30 using the generated moving image. On the other hand, in a case where the speed or the like of the mobile terminal 70 does not satisfy the predetermined criterion, the groove depth calculation apparatus 2000 does not generate the three-dimensional data 30 and outputs a notification for requesting re-photographing of the tire 10.

The groove depth calculation apparatus 2000 may determine whether the three-dimensional data 30 has been appropriately generated. When it is determined that the three-dimensional data 30 has been appropriately generated, the groove depth calculation apparatus 2000 calculates the real depth of the longitudinal groove of the tire 10 using the three-dimensional data 30. On the other hand, in a case where it is determined that the three-dimensional data 30 cannot be appropriately generated, the groove depth calculation apparatus 2000 outputs a notification for requesting re-photographing of the tire 10.

Whether the three-dimensional data 30 has been appropriately generated can be determined by, for example, whether the execution of the algorithm for generating the three-dimensional data 30 has been normally completed. That is, when the execution of the algorithm for generating the three-dimensional data 30 has been normally completed, it is determined that the three-dimensional data 30 is normally generated. On the other hand, when the execution of the algorithm for generating the three-dimensional data 30 has not been normally completed, it is determined that the three-dimensional data 30 has not been normally generated. For example, it is assumed that the three-dimensional data 30 is generated by SfM. In this case, when the SfM algorithm is normally completed, it is determined that the three-dimensional data 30 is normally generated. On the other hand, when the SfM algorithm has not been normally completed, it is determined that the three-dimensional data 30 is not normally generated.

The application 90 prompts the user 80 to input for determining the identification information of the tire 10. The application 90 acquires the specification information 40 using the information input by the user 80. When the identification information of the tire 10 is registered in advance in the mobile terminal 70, the application 90 may acquire the identification information of the tire 10 from the storage unit of the mobile terminal 70.

The application 90 calculates the real depth of the longitudinal groove of the tire 10 using the three-dimensional data 30 and the specification information 40. Further, the application 90 determines the degree of wear of the tire 10 using the calculated real depth of the longitudinal groove of the tire 10. Then, the application 90 displays the determination result on the display device of the mobile terminal 70.

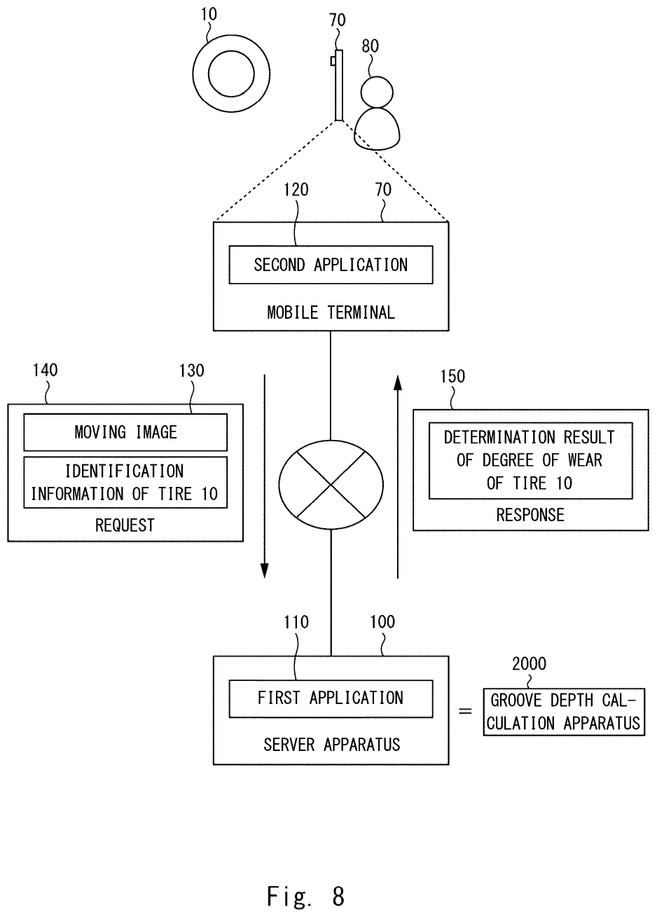

FIG. 8 is a second diagram illustrating an implementation example of the groove depth calculation apparatus 2000. The groove depth calculation apparatus 2000 in FIG. 8 is implemented by using a server apparatus 100. In the server apparatus 100, a first application 110 for causing the server apparatus 100 to function as the groove depth calculation apparatus 2000 is installed.

Also in the example of FIG. 8, the user 80 uses the mobile terminal 70 including the camera 50. However, a second application 120 is installed in the mobile terminal 70. The second application 120 is an application that functions as an interface between the user 80 and the groove depth calculation apparatus 2000.

The user 80 operates the mobile terminal 70 to start the second application 120. The second application 120 activates the camera 50 and sets the mode of the camera 50 to a mode for capturing a moving image. Further, the second application 120 instructs the user 80 to perform an operation of “moving the position of the mobile terminal 70 while the tire 10 is included in the imaging range of the camera 50”. The user 80 moves the position of the mobile terminal 70 according to the instruction. As a result, a moving image 130 including the tire 10 is generated.

The second application 120 prompts the user 80 to input for determining the identification information of the tire 10. However, when the identification information of the tire 10 is registered in advance in the mobile terminal 70, the second application 120 may acquire the identification information of the tire 10 from the storage unit of the mobile terminal 70.

The second application 120 transmits a request 140 for determining the degree of wear of the tire 10 to the server apparatus 100. The request 140 includes the identification information of the tire 10 and the moving image 130.

The first application 110 operating on the server apparatus 100 receives the request 140. The first application 110 generates the three-dimensional data 30 by using each of two or more moving image frames constituting the moving image 130 as the captured image 20. The first application 110 acquires the specification information 40 using the identification information of the tire 10. The first application 110 calculates the real depth of the longitudinal groove of the tire 10 using the three-dimensional data 30 and the specification information 40. The first application 110 determines the degree of wear of the tire 10 using the calculated real depth of the longitudinal groove of the tire 10.

The first application 110 transmits a response 150 indicating a determination result of the degree of wear of the tire 10 to the mobile terminal 70. The second application 120 operating on the mobile terminal 70 causes the display device of the mobile terminal 70 to display the determination result of the degree of wear of the tire 10 indicated in the received response 150.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

For example, the groove depth calculation apparatus 2000 may be configured to calculate the real depth of any groove other than the longitudinal groove provided in the tire 10.

The groove depth calculation apparatus 2000 may calculate the real depth of the groove of the tire 10 using a distance other than the distance between the longitudinal grooves of the tire 10 as a reference. For example, the groove depth calculation apparatus 2000 uses an arbitrary shape or pattern size of the tire 10 as a reference. As a specific example, the ratio between the virtual-space size of the predetermined mark provided on the tire 10 and the real-world size of the mark can be used as the ratio p described above.

In the above-described examples, the program includes a group of instructions (or software code) for causing a computer to perform one or more functions described in the example embodiments when being read by the computer. The program may be stored in a non-transitory computer-readable medium or a tangible storage medium. By way of example and not by way of limitation, the computer readable medium or the tangible storage medium includes a random-access memory (RAM), a read-only memory (ROM), a flash memory, a solid-state drive (SSD) or any other memory technique, a CD-ROM, a digital versatile disc (DVD), a Blu-ray (registered trademark) disc or any other optical disc storage, and a magnetic cassette, a magnetic tape, a magnetic disk storage, or any other magnetic storage device. The program may be transmitted through a transitory computer readable medium or a communication medium. By way of example and not by way of limitation, transitory computer-readable or communication media include electrical, optical, acoustic, or other forms of propagated signals.

Some or all of the example embodiments described above may also be described as, but are not limited to, the following Supplementary Notes.

### (Supplementary Note 1)

A groove depth calculation apparatus comprising:
a generation means for generating three-dimensional data representing a shape of a tire by using a plurality of captured images in which the same tire is captured;
a first calculation means for calculating a virtual-space depth of a longitudinal groove of the tire and a virtual-space distance between longitudinal grooves of the tire by using the three-dimensional data;
a determination means for determining a real-world distance between the longitudinal grooves of the tire; and
a second calculation means for calculating a real-world depth of the longitudinal groove of the tire based on a virtual-space distance between the longitudinal grooves of the tire, a real-world distance between the longitudinal grooves of the tire, and a virtual-space depth of the longitudinal groove of the tire.

### (Supplementary Note 2)

The groove depth calculation apparatus according to supplementary note 1,
wherein the first calculation means is configured to execute:
detecting a ground contact surface of the tire and a bottom surface of the longitudinal groove of the tire from the three-dimensional data; and
calculating, as a virtual-space depth of the longitudinal groove of the tire, a distance between the ground contact surface and the bottom surface in a virtual space to which the three-dimensional data belongs.

### (Supplementary Note 3)

The groove depth calculation apparatus according to supplementary note 1,
wherein the first calculation means is configured to execute:
detecting a plurality of the longitudinal grooves of the tire from the three-dimensional data; and
calculating, as a virtual-space distance between the longitudinal grooves of the tire, a distance between the two longitudinal grooves adjacent to each other in a virtual space to which the three-dimensional data belongs.

### (Supplementary Note 4)

The groove depth calculation apparatus according to supplementary note 1,
wherein the determination means is configured to execute:
acquiring identification information of the tire;
acquiring specification information that is associated with the acquired identification information, the specification information indicating a specification of the tire; and
determining a real-world distance between the longitudinal grooves of the tire from the acquired specification information.

### (Supplementary Note 5)

The groove depth calculation apparatus according to any one of supplementary notes 1 to 4,
wherein the second calculation means is configured to execute:
calculating a ratio of a real-world distance between longitudinal grooves of the tire to a virtual-space distance between the longitudinal grooves of the tire; and
calculating a real-world depth of the longitudinal groove of the tire based on the calculated ratio and a virtual-space depth of the longitudinal groove of the tire.

### (Supplementary Note 6)

The groove depth calculation apparatus according to supplementary note 5,
wherein the first calculation means is configured to execute calculating, for each pair of the longitudinal grooves adjacent to each other in the tire, a virtual-space distance between longitudinal grooves,
the determination means is configured to execute acquiring a real-world distance between longitudinal grooves for each of the pairs of longitudinal grooves, and
the second calculation means is configured to execute:
calculating a ratio of a real-world distance to a virtual-space distance for each of the pairs of longitudinal grooves; and
calculating a real-world depth of the longitudinal groove of the tire based on a statistical value of the calculated ratio and a virtual-space depth of the longitudinal groove of the tire.

### (Supplementary Note 7)

A groove depth calculation method performed by a computer, comprising:
a generation step of generating three-dimensional data representing a shape of a tire by using a plurality of captured images in which the same tire is captured;
a first calculation step of calculating a virtual-space depth of a longitudinal groove of the tire and a virtual-space distance between longitudinal grooves of the tire by using the three-dimensional data;
a determination step of determining a real-world distance between the longitudinal grooves of the tire; and
a second calculation step of calculating a real-world depth of the longitudinal groove of the tire based on a virtual-space distance between the longitudinal grooves of the tire, a real-world distance between the longitudinal grooves of the tire, and a virtual-space depth of the longitudinal groove of the tire.

### (Supplementary Note 8)

The groove depth calculation method according to supplementary note 7,
wherein in the first calculation step:
detecting a ground contact surface of the tire and a bottom surface of the longitudinal groove of the tire from the three-dimensional data; and
calculating, as a virtual-space depth of the longitudinal groove of the tire, a distance between the ground contact surface and the bottom surface in a virtual space to which the three-dimensional data belongs.

### (Supplementary Note 9)

The groove depth calculation method according to supplementary note 7,
wherein in the first calculation step:
detecting a plurality of the longitudinal grooves of the tire from the three-dimensional data; and
calculating, as a virtual-space distance between the longitudinal grooves of the tire, a distance between the two longitudinal grooves adjacent to each other in a virtual space to which the three-dimensional data belongs.

### (Supplementary Note 10)

The groove depth calculation method according to supplementary note 7,
wherein in the determination step:
acquiring identification information of the tire;
acquiring specification information that is associated with the acquired identification information, the specification information indicating a specification of the tire; and
determining a real-world distance between the longitudinal grooves of the tire from the acquired specification information.

### (Supplementary Note 11)

The groove depth calculation method according to any one of supplementary notes 7 to 10,
wherein in the second calculation step:
calculating a ratio of a real-world distance between longitudinal grooves of the tire to a virtual-space distance between the longitudinal grooves of the tire; and
calculating a real-world depth of the longitudinal groove of the tire based on the calculated ratio and a virtual-space depth of the longitudinal groove of the tire.

### (Supplementary Note 12)

The groove depth calculation method according to supplementary note 11,
wherein in the first calculation step, calculating, for each pair of the longitudinal grooves adjacent to each other in the tire, a virtual-space distance between longitudinal grooves,
in the determination step, acquiring a real-world distance between longitudinal grooves for each of the pairs of longitudinal grooves, and
in the second calculation step:
calculating a ratio of a real-world distance to a virtual-space distance for each of the pairs of longitudinal grooves; and
calculating a real-world depth of the longitudinal groove of the tire based on a statistical value of the calculated ratio and the virtual-space depth of the longitudinal groove of the tire.

### (Supplementary Note 13)

A non-transitory computer-readable medium that is configured to store a program that causes a computer to execute:
a generation step of generating three-dimensional data representing a shape of a tire by using a plurality of captured images in which the same tire is captured;
a first calculation step of calculating a virtual-space depth of a longitudinal groove of the tire and a virtual-space distance between longitudinal grooves of the tire by using the three-dimensional data;
a determination step of determining a real-world distance between the longitudinal grooves of the tire; and
a second calculation step of calculating a real-world depth of the longitudinal groove of the tire based on a virtual-space distance between the longitudinal grooves of the tire, a real-world distance between the longitudinal grooves of the tire, and a virtual-space depth of the longitudinal groove of the tire.

### (Supplementary Note 14)

The medium according to supplementary note 13,
wherein in the first calculation step:
detecting a ground contact surface of the tire and a bottom surface of the longitudinal groove of the tire from the three-dimensional data, and
calculating, as a virtual-space depth of the longitudinal groove of the tire, a distance between the ground contact surface and the bottom surface in a virtual space to which the three-dimensional data belongs.

### (Supplementary Note 15)

The medium according to supplementary note 13,
wherein in the first calculation step:
detecting a plurality of the longitudinal grooves of the tire from the three-dimensional data; and
calculating, as a virtual-space distance between the longitudinal grooves of the tire, a distance between the two longitudinal grooves adjacent to each other in a virtual space to which the three-dimensional data belongs.

### (Supplementary Note 16)

The medium according to supplementary note 13,
wherein in the determination step:
acquiring identification information of the tire;
acquiring specification information that is associated with the acquired identification information, the specification information indicating a specification of the tire; and
determining a real-world distance between the longitudinal grooves of the tire from the acquired specification information.

### (Supplementary Note 17)

The medium according to any one of supplementary notes 13 to 16,
wherein in the second calculation step:
calculating a ratio of a real-world distance between longitudinal grooves of the tire to a virtual-space distance between the longitudinal grooves of the tire; and
calculating a real-world depth of the longitudinal groove of the tire based on the calculated ratio and a virtual-space depth of the longitudinal groove of the tire.

### (Supplementary Note 18)

The medium according to supplementary note 17,
wherein in the first calculation step, calculating, for each pair of the longitudinal grooves adjacent to each other in the tire, a virtual-space distance between longitudinal grooves,
in the determination step, acquiring a real-world distance between longitudinal grooves for each of the pairs of longitudinal grooves, and
in the second calculation step:
calculating a ratio of a real-world distance to a virtual-space distance for each of the pairs of longitudinal grooves; and
calculating a real-world depth of the longitudinal groove of the tire based on a statistical value of the calculated ratio and the virtual-space depth of the longitudinal groove of the tire.

### REFERENCE SIGNS LIST

10 tire
20 captured image
30 three-dimensional data
32 three-dimensional data
34 plane
36 plane
40 specification information
42 identification information
44 distance information
50 camera
60 vehicle
70 mobile terminal
80 user
90 application
100 server apparatus
110 first application
120 second application
130 moving image
140 request
150 response
1000 computer
1020 bus
1040 processor
1060 memory
1080 storage device
1100 input/output interface
1120 network interface
2000 groove depth calculation apparatus
2020 generation unit
2040 first calculation unit
2060 determination unit
2080 second calculation unit

What is claimed is:

1. A groove depth calculation apparatus comprising:
at least one memory that is configured to store instructions; and
at least one processor that is configured to execute the instructions to:
generate three-dimensional data representing a shape of a tire by using a plurality of captured images in which the same tire is captured;
calculate a virtual-space depth of a longitudinal groove of the tire and a virtual-space distance between longitudinal grooves of the tire by using the three-dimensional data;
determine a real-world distance between the longitudinal grooves of the tire; and
calculate a real-world depth of the longitudinal groove of the tire based on a virtual-space distance between the longitudinal grooves of the tire, a real-world distance between the longitudinal grooves of the tire, and a virtual-space depth of the longitudinal groove of the tire.

2. The groove depth calculation apparatus according to claim 1,
wherein the calculation of the virtual-space depth of the longitudinal groove includes:
detecting a ground contact surface of the tire and a bottom surface of the longitudinal groove from the three-dimensional data; and
calculating, as the virtual-space depth of the longitudinal groove, a distance between the ground contact surface and the bottom surface in a virtual space to which the three-dimensional data belongs.

3. The groove depth calculation apparatus according to claim 1,
wherein the calculation of the virtual-space distance of the longitudinal grooves includes:
detecting a plurality of the longitudinal grooves from the three-dimensional data; and
calculating, as the virtual-space distance between the longitudinal grooves, a distance between the two longitudinal grooves adjacent to each other in a virtual space to which the three-dimensional data belongs.

4. The groove depth calculation apparatus according to claim 1,
wherein the determination of the real-world distance between the longitudinal grooves includes:
acquiring identification information of the tire;
acquiring specification information that is associated with the acquired identification information, the specification information indicating a specification of the tire; and
determining the real-world distance between the longitudinal grooves from the acquired specification information.

5. The groove depth calculation apparatus according to claim 1,
wherein the calculation of the real-world depth of the longitudinal groove includes:
calculating a ratio of the real-world distance between longitudinal grooves to the virtual-space distance between the longitudinal grooves; and
calculating the real-world depth of the longitudinal groove based on the calculated ratio and the virtual-space depth of the longitudinal groove.

6. The groove depth calculation apparatus according to claim 5,
wherein the calculation of the virtual-space distance between the longitudinal grooves includes calculating, for each pair of the longitudinal grooves adjacent to each other in the tire, the virtual-space distance between the longitudinal grooves,
the determination of the real-world distance between the longitudinal grooves includes acquiring the real-world distance between the longitudinal grooves for each of the pairs of the longitudinal grooves, and
the calculation of the real-world depth of the longitudinal groove includes
calculating a ratio of the real-world distance between the longitudinal grooves to the virtual-space distance between the longitudinal grooves for each of the pairs of the longitudinal grooves; and
calculating the real-world depth of the longitudinal groove based on a statistical value of the calculated ratio and the virtual-space depth of the longitudinal groove.

7. A groove depth calculation method performed by one or more computers, comprising:
generating three-dimensional data representing a shape of a tire by using a plurality of captured images in which the same tire is captured;
calculating a virtual-space depth of a longitudinal groove of the tire and a virtual-space distance between longitudinal grooves of the tire by using the three-dimensional data;
determining a real-world distance between the longitudinal grooves of the tire; and
calculating a real-world depth of the longitudinal groove of the tire based on a virtual-space distance between the longitudinal grooves of the tire, a real-world distance between the longitudinal grooves of the tire, and a virtual-space depth of the longitudinal groove of the tire.

8. The groove depth calculation method according to claim 7,
wherein the calculation of the virtual-space depth of the longitudinal groove includes:
detecting a ground contact surface of the tire and a bottom surface of the longitudinal groove of the tire from the three-dimensional data; and
calculating, as the virtual-space depth of the longitudinal groove of the tire, a distance between the ground contact surface and the bottom surface in a virtual space to which the three-dimensional data belongs.

9. The groove depth calculation method according to claim 7,
wherein the calculation of the virtual-space distance of the longitudinal grooves includes:
detecting a plurality of the longitudinal grooves of the tire from the three-dimensional data; and
calculating, as the virtual-space distance between the longitudinal grooves of the tire, a distance between the two longitudinal grooves adjacent to each other in a virtual space to which the three-dimensional data belongs.

10. The groove depth calculation method according to claim 7,
wherein the determination of the real-world distance between the longitudinal grooves includes:
acquiring identification information of the tire;
acquiring specification information that is associated with the acquired identification information, the specification information indicating a specification of the tire; and
determining the real-world distance between the longitudinal grooves of the tire from the acquired specification information.

11. The groove depth calculation method according to claim 7,
wherein the calculation of the real-world depth of the longitudinal groove includes:
calculating a ratio of the real-world distance between longitudinal grooves to the virtual-space distance between the longitudinal grooves; and
calculating the real-world depth of the longitudinal groove based on the calculated ratio and the virtual-space depth of the longitudinal groove.

12. The groove depth calculation method according to claim 11,
wherein the calculation of the virtual-space distance between the longitudinal grooves includes calculating, for each pair of the longitudinal grooves adjacent to each other in the tire, the virtual-space distance between the longitudinal grooves,
the determination of the real-world distance between the longitudinal grooves includes acquiring the real-world distance between the longitudinal grooves for each of the pairs of the longitudinal grooves, and
the calculation of the real-world depth of the longitudinal groove includes:
calculating a ratio of the real-world distance between the longitudinal grooves to the virtual-space distance between the longitudinal grooves for each of the pairs of the longitudinal grooves; and
calculating the real-world depth of the longitudinal groove based on a statistical value of the calculated ratio and the virtual-space depth of the longitudinal groove.

13. A non-transitory computer-readable medium that is configured to store a program that causes one or more computers to execute:
generating three-dimensional data representing a shape of a tire by using a plurality of captured images in which the same tire is captured;
calculating a virtual-space depth of a longitudinal groove of the tire and a virtual-space distance between longitudinal grooves of the tire by using the three-dimensional data;
determining a real-world distance between the longitudinal grooves of the tire; and
calculating a real-world depth of the longitudinal groove of the tire based on a virtual-space distance between the longitudinal grooves of the tire, a real-world distance between the longitudinal grooves of the tire, and a virtual-space depth of the longitudinal groove of the tire.

14. The medium according to claim 13,
wherein the calculation of the virtual-space depth of the longitudinal groove includes:
detecting a ground contact surface of the tire and a bottom surface of the longitudinal groove of the tire from the three-dimensional data, and
calculating, as the virtual-space depth of the longitudinal groove of the tire, a distance between the ground contact surface and the bottom surface in a virtual space to which the three-dimensional data belongs.

15. The medium according to claim 13,
wherein the calculation of the virtual-space distance of the longitudinal grooves includes:
detecting a plurality of the longitudinal grooves of the tire from the three-dimensional data; and
calculating, as the virtual-space distance between the longitudinal grooves of the tire, a distance between the two longitudinal grooves adjacent to each other in a virtual space to which the three-dimensional data belongs.

16. The medium according to claim 13,
wherein the determination of the real-world distance between the longitudinal grooves includes:
acquiring identification information of the tire;
acquiring specification information that is associated with the acquired identification information, the specification information indicating a specification of the tire; and
determining the real-world distance between the longitudinal grooves of the tire from the acquired specification information.

17. The medium according to claim 13,
wherein the calculation of the real-world depth of the longitudinal groove includes:
calculating a ratio of the real-world distance between longitudinal grooves to the virtual-space distance between the longitudinal grooves; and
calculating the real-world depth of the longitudinal groove based on the calculated ratio and the virtual-space depth of the longitudinal groove.

18. The medium according to claim 17,
wherein the calculation of the virtual-space distance between the longitudinal grooves includes calculating, for each pair of the longitudinal grooves adjacent to each other in the tire, the virtual-space distance between the longitudinal grooves,
the determination of the real-world distance between the longitudinal grooves includes acquiring the real-world distance between the longitudinal grooves for each of the pairs of the longitudinal grooves, and
the calculation of the real-world depth of the longitudinal groove includes:
calculating a ratio of the real-world distance between the longitudinal grooves to the virtual-space distance between the longitudinal grooves for each of the pairs of the longitudinal grooves; and
calculating the real-world depth of the longitudinal groove based on a statistical value of the calculated ratio and the virtual-space depth of the longitudinal groove.
